(19) United States
(12) Patent Application Publication
(10) Pub. No.: US 2026/0200189 A1
(43) Pub. Date: Jul. 16, 2026

(54) LEAK-PROOF LIQUID METAL/MELAMINE INSULATING AND THERMALLY CONDUCTIVE FILM AND PREPARATION METHOD THEREOF

(71) Applicant: Sichuan University, Chengdu (CN)

(72) Inventors: Lichuan Jia, Chengdu (CN); Zhixing Wang, Chengdu (CN); Runpan Nie, Chengdu (CN); Mengxin Liu, Chengdu (CN); Jiawei Wu, Chengdu (CN); Dingxiang Yan, Chengdu (CN); Shenli Jia, Chengdu (CN); Zhongming Li, Chengdu (CN)

(21) Appl. No.: 19/419,705

(22) Filed: Dec. 15, 2025

(30) Foreign Application Priority Data
Jan. 14, 2025 (CN) 202510053130.X

(51) Int. Cl. B29D 7/01; B29B 13/08; B29B 15/10; B29C 35/02; B29C 43/36; B29C 43/58; C08J 9/40; C08K 3/08; C08K 3/105; C08K 5/17; C08K 5/3492

(52) U.S. Cl. CPC B29D 7/01; B29B 13/08; B29B 15/10; B29C 35/02; C08J 9/405; C08K 3/105; C08K 5/17; C08K 5/34922; B29C 2043/3623; B29C 2043/5808; B29C 2043/5825; C08K 2003/0806

(57) ABSTRACT

A leak-proof liquid metal (LM)/melamine insulating and thermally conductive film and a preparation method thereof. The preparation method comprises the following steps: (1) selecting a sponge substrate: the substrate is a composite modified sponge; (2) selecting a LM; (3) preparing a LM/ethanol dispersion; (4) performing impregnation treatment on the melamine sponge; (5) performing drying treatment; (6) performing multiple impregnations; (7) pressing the LM component; (8) preparing a Polydimethylsiloxane (PDMS)/ethyl acetate solution; (9) molding. The composite modified sponge of the invention possesses large pore sizes and a rich three-dimensional network structure, thereby combining an extremely low density with excellent flexibility, the sponge after composite modification treatment exhibits higher intrinsic thermal conductivity and a significantly improved adsorption effect for the LM. The extremely high porosity of the composite sponge and the interaction force with the LM also enable it to carry a filler loading of more than 60 vol % without leakage.

### TECHNICAL FIELD

The invention belongs to the technical field of polymer materials, and particularly relates to a leak-proof liquid metal/melamine insulating and thermally conductive film and a preparation method thereof.

### BACKGROUND ART

Thermal interface materials are currently widely used in various electronic and electrical equipment requiring efficient thermal management, and their main function is to fill interface gaps, reduce contact thermal resistance, thereby improving equipment heat dissipation capacity and ensuring thermal stability and reliability. Traditional thermal conductive composites mainly use metal materials and carbon-based materials. Although they have high thermal conductivity, because the fillers are rigid particles. At low filler loadings, the fillers cannot form a dense and effective thermal conduction network within the matrix, limiting the improvement of the composite's thermal conductivity; when the filler loading is too high, it is often accompanied by a significant decrease in mechanical properties. This manifests as insufficient flexibility or unstable compression performance at interfaces with complex structures, inability to fully fill microscopic voids, and difficulty in utilizing the composite's thermal conductivity. The disordered arrangement of fillers in the composite also greatly reduces their utilization efficiency. In some special scenarios (such as new energy vehicle battery modules), materials are required to possess both excellent thermal conductivity and meet specific electrical insulation properties, which are difficult to achieve with traditional composite materials.

As an emerging material, liquid metal (LM), with its unique physical state, being liquid at room temperature and having high thermal conductivity (>16.5 W/m·K), opens a new path for the innovative design of flexible composites. The fluidity of LM allows it to penetrate into the internal structure of composite materials and to form stable and efficient heat conduction pathways.

Melamine sponge, which uses melamine as raw material, has bendable flexibility that makes it an excellent choice as a substrate for thermal interface materials. Its fine, abundant three-dimensional mesh structure and large pore size enable it to effectively carry a higher content of LM, thereby forming an efficient thermal conduction network while avoiding LM leakage. Melamine sponge has good processing performance and can be made into components of various shapes and sizes through processes such as mold pressing to adapt to various complex application scenarios.

Chinese Patent Publication No. CN114940829B shows a two-dimensional graphene/LM/PDMS composite film and its preparation method, this invention uses photosensitive resin as a skeleton, fills it with PDMS, and then demolds to obtain a flexible PDMS substrate, which can provide a heat conduction path for the filler, thereby improving thermal conductivity. However, this method involves excessive filling of PDMS, which inhibits the improvement of thermal conductivity, although it can impart certain flexibility to the composite material, the heat conduction path is easily blocked under mechanical deformation, and there is a risk of LM leakage.

Chinese Patent Application No. CN202210597791.5 shows a composite high thermal conductivity interlayer gasket based on LM filling and its preparation method. However, the hardness of this composite material is still relatively high, it lacks flexibility, and its thermal conductivity is less than 5 W·m⁻¹·K⁻¹, unable to meet thermal conductivity requirements in complex scenarios.

Existing preparation methods for LM-based thermally conductive composites face the problem of leakage under high filler loading, and a contradiction between high thermal conductivity and flexibility in thermal conductive composites, while also needing to ensure good insulation performance in specific scenarios. Based on this, the invention provides a leak-proof LM/melamine insulating thermally conductive film and a preparation method thereof to solve the existing technical problems.

### SUMMARY OF THE INVENTION

The objective of the invention is to provide a leak-proof LM/melamine insulating and thermally conductive film and a preparation method thereof, to overcome the shortcomings in the prior art.

The technical solution adopted by the invention is as follows:
a preparation method for a leak-proof LM/melamine insulating thermally conductive film, the preparation method comprising the following steps:
(1) sponge substrate selection: the selected substrate is a composite modified sponge;
(2) LM selection: employing a gallium-indium alloy;
(3) preparation of a LM/ethanol dispersion: mixing the LM and ethanol, then placing the mixture into an ultrasonic cell disruptor for disruption to obtain a LM/ethanol dispersion;
wherein the mass ratio of the LM to ethanol is 1:12 to 1:18, the ultrasonic power is 400 W, and the processing time is 2-6 minutes;
(4) melamine sponge impregnation treatment: placing the composite modified sponge obtained in step (1) into the LM/ethanol dispersion obtained in step (3) according to a volume ratio of 1:5 for impregnation treatment, then taking it out to obtain an impregnated sample;
(5) drying treatment: placing the impregnated sample obtained in step (4) into an air drying oven for drying treatment until the ethanol is completely evaporated;
wherein the air speed inside the air drying oven is 0.5 m/s, the temperature is 50° C., and the time is 0.5 hours;
(6) multiple impregnations: repeating steps (4) and (5) multiple times to obtain a multiple-impregnated composite material;
(7) LM component pressing: mechanically pressing the multiple-impregnated composite material obtained in step (6) to obtain a film sample;
(8) preparation of Polydimethylsiloxane (PDMS)/Ethyl acetate solution: PDMS and a curing agent are taken according to a mass ratio of 9:1 and mixed uniformly to obtain a preliminary mixture; the preliminary mixture is poured into ethyl acetate according to a mass ratio of preliminary mixture to ethyl acetate of 1:9 into a centrifuge tube, followed by centrifugal stirring for 5 minutes to prepare a 10% PDMS/ethyl acetate solution; the obtained solution is diluted 10 times to obtain a 1% PDMS/ethyl acetate solution;
(9) molding: suspending the film sample obtained in step (7) on an aluminum mesh support to reduce contact between the LM and the support; aspirating the 1% PDMS/ethyl acetate solution obtained in step (8) with a pipette, dripping it onto both sides of the film sample for uniform coverage, placing it in an air drying oven to evaporate the ethyl acetate, and finally obtaining the leak-proof LM/melamine insulating thermally conductive film;
wherein the air speed inside the air drying oven is 0.5 m/s, the temperature is 60° C., and the time is 2 hours.

As a further technical solution, the selected composite modified sponge has a density of 0.0080-0.0085 g/cm³ and a thickness of 0.4-0.6 cm.

As a further technical solution, in step (8), the curing agent is tetraethylthiuram disulfide;
as a further technical solution, the preparation method of the composite modified sponge comprises the following steps:
(1) repeatedly rinsing a melamine sponge with anhydrous ethanol and deionized water for 10 minutes each, then vacuum drying at a temperature of 55° C. for 2 hours to obtain a cleaned melamine sponge;
(2) uniformly dispersing silver nanowires into deionized water to obtain a silver nanowire dispersion.
(3) immersing the cleaned melamine sponge into the silver nanowire dispersion, applying a pressure of 0.5 MPa to the cleaned melamine sponge, holding the pressure for 10 seconds, then releasing the pressure, maintaining for 20 seconds, repeating this cycle 5 times; then taking it out, placing it in a vacuum drying oven, and vacuum drying at 55° C. for 4 hours to obtain a melamine sponge composite material;
(4) adding dopamine hydrochloride to a Tris solution, stirring and mixing uniformly to obtain a treatment solution;
adding the melamine sponge composite material to the treatment solution, performing ultrasonic dispersion for 10 minutes, adjusting the temperature to 65° C., maintaining a sealed impregnation for 15 hours, taking it out, and then vacuum drying at a temperature of 55° C. for 4 hours to obtain the composite modified sponge.

As a further technical solution, the mass fraction of the silver nanowires in the silver nanowire dispersion is 10-13 wt %;
the cleaned melamine sponge is immersed into the silver nanowire dispersion according to a volume ratio of 1:10;
the mixing ratio of dopamine hydrochloride to Tris solution is 1-1.2 g: 120 mL;
the volume ratio of the melamine sponge composite material to the treatment solution is 1:5.

As a further technical solution, the gallium-indium alloy has a mass fraction of gallium of 75.5% and a mass fraction of indium of 24.5%.

As a further technical solution, the vacuum impregnation time is 4-5 hours, the vacuum degree is 0.1 Pa, and the temperature is 70° C.

As a further technical solution, the multiple repetitions of steps (4) and (5) specifically means repeating 1-4 times.

As a further technical solution, the mechanical pressing step comprises: dividing the obtained multiple-impregnated composite material into four parts, placing them into a tablet press for automatic pressing, wherein the tablet press acts on one of the four parts each time, four times constitute one cycle, and a total of 10-12 cycles are performed.

It should be noted that the mechanical pressing in the invention is not sintering in the traditional sense, but rather achieving bonding between LMs by applying pressure at room temperature, i.e., the process of mechanical pressing. This mechanical pressing is a solid-state connection technology that does not rely on the traditional high-temperature sintering process but achieves connection between materials by applying external pressure.

As a further technical solution, the pressing pressure is 1 MPa, and the pressing time is 2 seconds per time.

As a further technical solution, in step (9), the amount of solution dripped on each side of the film sample is 20 μL/cm², respectively.

### Beneficial Effects

1. Melamine sponge is mainly composed of melamine resin, and its surface chemical properties have weak compatibility with LM, mainly combining through physical interlocking and weak van der Waals forces, resulting in low binding energy. The invention subjects the melamine sponge substrate to composite modification treatment, introducing silver nanowires for combination, silver nanowires have a high free electron density and may produce stronger interactions with the surface electron cloud of the LM. Furthermore, gallium in the LM can usually form a stable gallium oxide film, and this oxide layer can combine with the silver surface through van der Waals forces or chemical bonds on the metal surface, resulting in higher binding energy, thereby making the composite-modified melamine sponge more adsorbent to the LM.

2. The invention immerses the modified melamine sponge in the LM/ethanol dispersion, the LM in the dispersion fully penetrates and fills the pores of the modified melamine sponge through capillary action, forming a good physical combination; meanwhile, the LM has high surface tension and will automatically contract and adhere to the pore wall surface within the pores, during air drying, the increase in temperature causes the LM to flow further, fully covering the pore walls of the melamine sponge, further enhancing its adhesion; in the subsequent step-by-step pressing process, the LM fills the voids due to pore compression, with the excess flowing to the edges, after multiple cycles, a LM film with micron-level thickness is finally formed. The LM transitions from small droplets attached to the skeleton to sheet-like forms after pressing, filling the interior of the film.

Since the binding force between LMs is mainly determined by surface tension, and the skeleton of the melamine sponge is extremely fine, making its rebound force much smaller than the binding force between the LMs, the film does not revert to a porous sponge state after formation. Washing the LM inside the film with anhydrous ethanol allows the film to rebound back into a porous sponge morphology, which also proves that the invention does not achieve the non-rebound effect by permanently destroying the skeleton of the melamine sponge, but rather utilizes the difference between the binding force of the LM and the rebound force of the melamine sponge to achieve stable control of the film morphology.

3. The invention controls the average particle size of the LM particles in the LM/ethanol dispersion through specific ultrasonic time and power, at this average particle size, the combination degree between the LM and the melamine sponge is the highest, which is most advantageous for material molding.

4. The invention also forms a micron-level protective layer on the film surface through the use of PDMS, which further prevents LM leakage without significantly altering the overall morphology, while also providing effective insulation performance and significantly improving the flexibility and durability of the material, it can maintain stable mechanical properties over a wide temperature range from 20° C. to 150° C. Especially in multiple cyclic deformation tests (such as bending and compression), after more than 1000 cycles, its mechanical properties, insulation performance, and thermal conductivity show no significant attenuation, demonstrating excellent anti-fatigue performance.

5. The invention has a simple production process, low cost, good performance, and is suitable for mass production.

### BRIEF DESCRIPTION OF THE DRAWINGS

FIG. 1 is a scanning electron micrograph of the LM/ethanol dispersion with an ultrasonic time of 2 minutes in Embodiment 6;

FIG. 2 is a scanning electron micrograph of the LM/ethanol dispersion with an ultrasonic time of 4 minutes in Embodiment 1;

FIG. 3 is a cross-sectional scanning electron micrograph of the thermally conductive film prepared in Comparative Embodiment 4;

FIG. 4 is a scanning electron micrograph of the surface after PDMS coating in Embodiment 5;

FIG. 5 is a schematic diagram of Example 5 under pressures of 100, 300, and 500 kPa.

FIG. 6 is a schematic diagram of the process flow of the preparation method of the invention.

### SPECIFIC EMBODIMENT OF THE INVENTION

The technical solutions in the embodiments of the invention will be clearly and completely described hereinafter, obviously, the described embodiments are only a part of the embodiments of the invention, not all of them. Based on the embodiments of the invention, all other embodiments obtained by a person of ordinary skill in the art without making creative efforts shall fall within the protection scope of the invention.

The following are specific embodiments:

### Embodiment 1

A preparation method for a leak-proof LM/melamine insulating thermally conductive film, the preparation method comprising the following steps:
(1) sponge substrate selection: the selected substrate is a composite modified sponge;
(2) LM selection: employing a gallium-indium alloy;
(3) preparation of a LM/ethanol dispersion: mixing the LM and ethanol, then placing the mixture into an ultrasonic cell disruptor for disruption to obtain a LM/ethanol dispersion;
wherein the mass ratio of the LM to ethanol is 1:12, the ultrasonic power is 400 W, and the processing time is 4 minutes;
(4) melamine sponge impregnation treatment: placing the composite modified sponge obtained in step (1) into the LM/ethanol dispersion obtained in step (3) according to a volume ratio of 1:5 for impregnation treatment, then taking it out to obtain an impregnated sample;
(5) drying treatment: placing the impregnated sample obtained in step (4) into an air drying oven for drying treatment until the ethanol is completely evaporated;
wherein the air speed inside the air drying oven is 0.5 m/s, the temperature is 50° C., and the time is 0.5 hours;
(6) multiple impregnations: in this embodiment, steps (4) and (5) are not repeated, obtaining an impregnated composite material;
(7) LM component pressing: mechanically pressing the multiple-impregnated composite material obtained in step (6) to obtain a film sample;
(8) preparation of a PDMS/ethyl acetate solution: taking PDMS and a curing agent according to a mass ratio of 9:1 and mixing them uniformly to obtain a preliminary mixture, pouring the preliminary mixture into ethyl acetate according to a mass ratio of preliminary mixture to ethyl acetate of 1:9 into a centrifuge tube, centrifugally stirring for 5 minutes to prepare a 10% PDMS/ethyl acetate solution, and diluting the obtained solution 10 times to obtain a 1% PDMS/ethyl acetate solution;
the curing agent is tetraethylthiuram disulfide;
(9) suspending the film sample obtained in step (7) on an aluminum mesh support to reduce contact between the LM and the support; aspirating the 1% PDMS/ethyl acetate solution obtained in step (8) with a pipette, dripping it onto both sides of the film sample for uniform coverage, placing it in an air drying oven to evaporate the ethyl acetate, and finally obtaining the leak-proof LM/melamine insulating thermally conductive film;
wherein the air speed inside the air drying oven is 0.5 m/s, the temperature is 60° C., and the time is 2 hours.

The composite modified sponge has a density of 0.0083 g/cm³ and a thickness of 0.5 cm.

The preparation method of the composite modified sponge comprises the following steps:
(1) repeatedly rinsing a melamine sponge with anhydrous ethanol and deionized water for 10 minutes each, then vacuum drying at a temperature of 55° C. for 2 hours to obtain a cleaned melamine sponge;
(2) uniformly dispersing silver nanowires into deionized water to obtain a silver nanowire dispersion.
(3) immersing the cleaned melamine sponge into the silver nanowire dispersion, applying a pressure of 0.5 MPa to the cleaned melamine sponge, holding the pressure for 10 seconds, then releasing the pressure, maintaining for 20 seconds, repeating this cycle 5 times, then taking it out, placing it in a vacuum drying oven, and vacuum drying at 55° C. for 4 hours to obtain a melamine sponge composite material;
(4) adding dopamine hydrochloride to a Tris solution, stirring and mixing uniformly to obtain a treatment solution;
adding the melamine sponge composite material to the treatment solution, performing ultrasonic dispersion for 10 minutes, adjusting the temperature to 65° C., maintaining a sealed impregnation for 15 hours, taking it out, and then vacuum drying at a temperature of 55° C. for 4 hours to obtain the composite modified sponge.

The mass fraction of the silver nanowires in the silver nanowire dispersion is 10 wt %;
the cleaned melamine sponge is immersed into the silver nanowire dispersion according to a volume ratio of 1:10;
the mixing ratio of dopamine hydrochloride to Tris solution is 1 g: 120 mL;
the volume ratio of the melamine sponge composite material to the treatment solution is 1:5.

The gallium-indium alloy has a mass fraction of gallium of 75.5% and a mass fraction of indium of 24.5%.

The vacuum impregnation time is 4.5 hours, the vacuum degree is 0.1 Pa, and the temperature is 70° C.

The mechanical pressing specifically comprises: dividing the obtained multiple-impregnated composite material into four parts, placing them into a tablet press for automatic pressing, wherein the tablet press acts on one of the four parts each time, four times constitute one cycle, and a total of 10 cycles are performed. The pressure is set to 1 MPa, and the pressing time is 2 seconds per time.

The dripping amount on each side of the film sample is 20 μL/cm² of the 1% PDMS/ethyl acetate solution.

### Embodiment 2

As a preparation method for a leak-proof LM/melamine insulating thermally conductive film according to an embodiment of the invention, the only difference between this embodiment and Embodiment 1 is that the impregnation in step 6 is repeated once.

### Embodiment 3

As a preparation method for a leak-proof LM/melamine insulating thermally conductive film according to an embodiment of the invention, the only difference between this embodiment and Embodiment 1 is that the number of repetitions in step 6 of the preparation method is 2 times.

### Embodiment 4

As a preparation method for a leak-proof LM/melamine insulating thermally conductive film according to an embodiment of the invention, the only difference between this embodiment and Embodiment 1 is that the number of repetitions in step 6 of the preparation method is 3 times.

### Embodiment 5

As a preparation method for a leak-proof LM/melamine insulating thermally conductive film according to an embodiment of the invention, the only difference between this embodiment and Embodiment 1 is that the number of repetitions in step 6 of the preparation method is 4 times.

### Embodiment 6

As a leak-proof LM/melamine insulating thermally conductive film and preparation method thereof according to an embodiment of the invention, the only difference between this embodiment and Embodiment 1 is that the disruption time in the ultrasonic cell disruptor is 2 minutes.

### Embodiment 7

As a leak-proof LM/melamine insulating thermally conductive film and preparation method thereof according to an embodiment of the invention, the only difference between this embodiment and Embodiment 1 is that the disruption time in the ultrasonic cell disruptor is 6 minutes.

### Comparative Embodiment 1

As a preparation method for a thermally conductive film according to an embodiment of the invention, the only difference between this comparative example and Embodiment 5 is that the impregnated film is not subjected to mechanical pressing.

### Comparative Embodiment 2

As a preparation method for a thermally conductive film according to an embodiment of the invention, the difference between this comparative example and Embodiment 5 is that in the mechanical pressing step of this comparative example, the sample is not divided into four parts but is pressed as a whole piece, still pressed 10 times.

### Comparative Embodiment 3

As a preparation method for a thermally conductive film according to an embodiment of the invention, the difference between this comparative example and Embodiment 5 is that the melamine sponge is not subjected to composite modification treatment in this comparative example.

### Comparative Embodiment 4

As a preparation method for a thermally conductive film according to an embodiment of the invention, the difference between this comparative example and Embodiment 5 is that the film sample is not subjected to PDMS coating treatment in this comparative example, i.e., steps (8) and (9) are not performed.

### Testing:

Tests were conducted on the films prepared in Embodiments 1-7 and Comparative Embodiments 1-4 to verify the volume fraction before and after pressing, and the thermal conductivity before and after PDMS coating. The test results are shown in Table 1:
among them, the thermal conductivity test refers to GB/T 29313-2012.

| | | | | Thermal |
|---|---|---|---|---|
| | Volume | Volume | | Conductivity |
| | Fraction | Fraction | Thermal | (W/m · K) |
| | (Before | (After | Conductivity | (After PDMS |
| | Pressing) | Pressing) | (W/m · K) | Coating) |
| Embodiment 1 | 0.98 | 44.93 | 7.49 | 7.33 |
| Embodiment 2 | 2.01 | 49.87 | 9.54 | 9.41 |
| Embodiment 3 | 3.00 | 55.28 | 11.24 | 11.09 |
| Embodiment 4 | 3.97 | 60.15 | 12.51 | 12.44 |
| Embodiment 5 | 5.02 | 65.21 | 13.48 | 13.32 |
| Embodiment 6 | 0.99 | 45.04 | 6.88 | 6.56 |
| Embodiment 7 | 0.97 | 44.99 | 6.95 | 6.81 |
| Comparative | 1.01 | / | 0.25 | / |
| Embodiment 1 | | | | |
| Comparative | 0.99 | 35.22 | 3.83 | 3.66 |
| Embodiment 2 | | | | |
| Comparative | 3.98 | 59.22 | 5.66 | 5.41 |
| Embodiment 3 | | | | |
| Comparative | 5.01 | 65.11 | 13.21 | / |
| Embodiment 4 | | | | |

Based on the data analysis of Embodiments 1 to 5 in Table 1, at least the following points can be obtained:

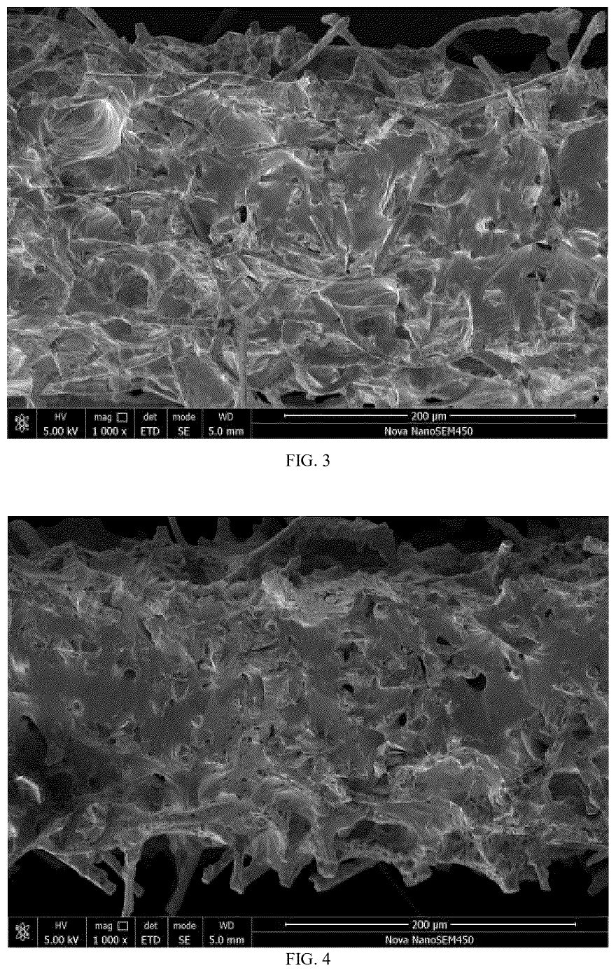

1. After each impregnation process, the volume fraction of the LM attached to the composite-modified melamine sponge remains stable at approximately 1%. Furthermore, after the pressing treatment, the volume fraction of the LM shows a regular changing trend. This phenomenon can be attributed to the binding force between the LMs and the binding force between the LM and the silver nanowires, which significantly surpasses the rebound force of the melamine sponge itself, thus promoting the effective filling of the voids between the melamine sponge by the LM during the pressing process, as shown in FIG. 3.

2. To further optimize the material performance, we coated an extremely thin layer of PDMS elastomer on the film surface, as shown in FIG. 4. It is worth noting that the thickness of this PDMS layer is only at the micron level and does not penetrate into the interior of the film, so it hardly has a significant impact on the overall thermal conductivity of the material. Moreover, this PDMS layer provides external insulation performance for the film and can further prevent LM leakage.

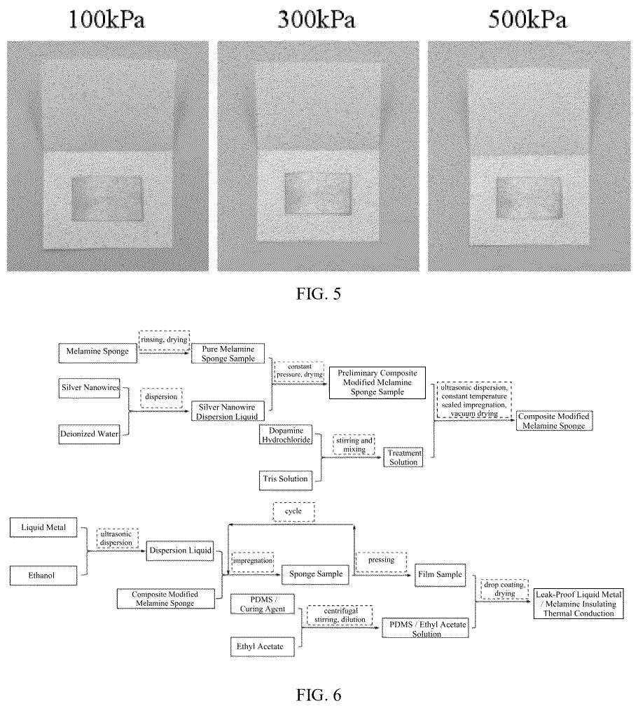

Correspondingly, a pressure test was performed on Embodiment 5, as shown in FIG. 5, the film of Embodiment 5 showed no LM leakage under pressures of 100 kPa, 300 kPa, and 500 kPa.

This is not only due to the encapsulation by PDMS but also because after the melamine sponge is mechanically pressed into a film, the LM exists more in the form of sheets rather than droplets inside the film; sheet-like LM, due to its structural characteristics, has a larger lateral area and smaller thickness, resulting in a relatively larger contact area with the substrate surface. This larger contact area enhances the adhesion of the LM to the film and the silver nanowires through the surface tension effect, making it more stably fixed on the substrate and reducing its mobility and leakage risk under external forces.

The technical solution of the invention balances the thermal conduction performance of the material with the required elasticity, sealing, and other characteristics to meet the comprehensive performance requirements in specific application scenarios.

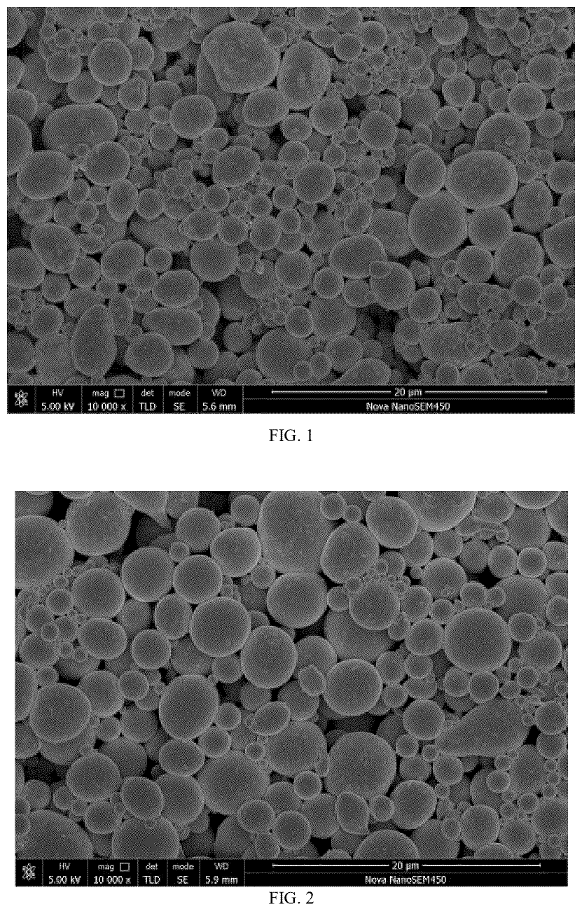

3. From Table 1, Embodiments 1, 6, and 7, it can be seen that too short or too long ultrasonic time affects the distribution of the LM on the skeleton. As shown in FIGS. 1 and 2, when the LM dispersion is treated with ultrasound, as the ultrasonic time increases, the particle size of the LM particles overall shows a decreasing trend. This is because effects such as cavitation, shear, and micro-jet flow generated by ultrasound act on the LM particles, subjecting them to strong impact and shear forces, leading to particle fragmentation and refinement. However, when the ultrasonic time reaches a certain level, excessively small LM droplets may reagglomerate, causing certain fluctuations in the particle size distribution and an increase in the average particle size. Therefore, through multiple ultrasonic experiments, the inventors found that an ultrasonic time of about 4 minutes results in the smallest average particle size of the LM droplets and the best adsorption effect for the composite modified melamine sponge.

4. From Embodiment 1 and Comparative Embodiments 1 and 2, it can be seen that the melamine sponge without pressing treatment does not show a significant improvement in thermal conductivity. The root cause of this phenomenon lies in the distribution state of the LM particles on the melamine sponge skeleton-they exhibit an uneven dispersion and fail to effectively construct a continuous thermal conduction network; performing the mechanical pressing step without dividing the melamine sponge into blocks causes the sponge to withstand an overall pressure, reducing the flow range of the LM; unlike block-wise mechanical pressing where the LM can flow to other uncompressed directions within the sponge, this leads to insufficient penetration of the LM in the formed film, affecting the final thermal conductivity.

5. From Embodiment 1 and Comparative Embodiment 3, it can be seen that the melamine sponge without composite modification has only 80% of the adsorption effect on the LM compared to the modified one, and the thermal conductivity is also significantly reduced, this is because silver nanowires, due to their high free electron density, can form strong interactions with the electron cloud on the surface of the LM; furthermore, gallium in the LM usually generates a stable gallium oxide film, and this oxide film can firmly combine with the silver surface through van der Waals forces or chemical bonds, thereby significantly increasing the interfacial binding energy and thus enhancing the sponge's adsorption for the LM. Meanwhile, the silver nanowires also act as bridges in the film structure, further optimizing path connections, thereby significantly improving the thermal conductivity of the film.

Therefore, it can be concluded that the uniform dispersion of LM particles on the melamine sponge skeleton and the construction of a continuous thermal conduction network through pressing treatment are key to achieving a significant improvement in the thermal conductivity of the melamine sponge; the presence of sheet-like LM inside the film increases its adhesion to the substrate, as it has a higher contact area and lower curvature, making it less likely to move under gravity or external forces; meanwhile, the interaction force between the LM and the silver nanowires is also key to ensuring no leakage of the LM; the presence of the PDMS protective layer further enhances the film's leakage prevention ability and increases its flexibility while providing insulation performance. This discovery has important guiding significance for subsequent material design and preparation processes.

The hereinabove descriptions are only embodiments of the invention and are not intended to limit the patent scope of the invention, any equivalent structure or equivalent process transformation made using the description and drawings of the invention, or directly or indirectly applied in other related technical fields, shall similarly be included within the patent protection scope of the invention.

1. A preparation method for a leak-proof liquid metal (LM)/melamine insulating and thermally conductive film, wherein the preparation method comprises the following steps:
(1) sponge substrate selection: the selected substrate is a composite modified sponge;
(2) LM selection: employing a gallium-indium alloy;
(3) preparation of a LM/ethanol dispersion: mixing the LM and ethanol, then placing the mixture into an ultrasonic cell disruptor for disruption to obtain a LM/ethanol dispersion;
the mass ratio of the LM to ethanol is 1:12 to 1:18, the ultrasonic power is 400 W, and the processing time is 2-6 minutes;
(4) melamine sponge impregnation treatment: placing the composite modified sponge obtained in step (1) into the LM/ethanol dispersion obtained in step (3) according to a volume ratio of 1:5 for impregnation treatment, then taking it out to obtain an impregnated sample;
(5) drying treatment: placing the impregnated sample obtained in step (4) into an air drying oven for drying treatment until the ethanol is completely evaporated;
wherein the air speed inside the air drying oven is 0.5 m/s, the temperature is 50° C., and the time is 0.5 hours;
(6) multiple impregnations: repeating steps (4) and (5) multiple times to obtain a multiple-impregnated composite material;
(7) LM component pressing: mechanically pressing the multiple-impregnated composite material obtained in step (6) to obtain a film sample; the mechanical pressing step comprises: dividing the obtained multiple-impregnated composite material into four parts, placing them into a tablet press for automatic pressing, wherein the tablet press acts on one of the four parts each time, four times constitute one cycle, and a total of 10 to 12 cycles are performed;
(8) Polydimethylsiloxane (PDMS)/ethyl acetate solution preparation: taking PDMS and a curing agent according to a mass ratio of 9:1 and mixing them uniformly to obtain a preliminary mixture, pouring the preliminary mixture into ethyl acetate according to a mass ratio of preliminary mixture to ethyl acetate of 1:9 into a centrifuge tube, centrifugally stirring for 5 minutes to prepare a 10% PDMS/ethyl acetate solution, and diluting the obtained solution 10 times to obtain a 1% PDMS/ethyl acetate solution;
(9) molding: suspending the film sample obtained in step (7) on an aluminum mesh support, aspirating the 1% PDMS/ethyl acetate solution obtained in step (8) with a pipette, dripping it onto both sides of the film sample for uniform coverage, placing it in an air drying oven to evaporate the ethyl acetate, and finally obtaining the leak-proof LM/melamine insulating thermally conductive film;
the air speed inside the air drying oven is 0.5 m/s, the temperature is 60° C., and the time is 2 hours;
the preparation method of the composite modified sponge comprises the following steps:
(1) repeatedly rinsing a melamine sponge with anhydrous ethanol and deionized water for 10 minutes each, then vacuum drying at a temperature of 55° C. for 2 hours to obtain a cleaned melamine sponge;
(2) uniformly dispersing silver nanowires into deionized water to obtain a silver nanowire dispersion; the mass fraction of the silver nanowires in the silver nanowire dispersion is 10-13 wt %;
(3) immersing the cleaned melamine sponge into the silver nanowire dispersion, applying a pressure of 0.5 MPa to the cleaned melamine sponge, holding the pressure for 10 seconds, then releasing the pressure, maintaining for 20 seconds, repeating this cycle 5 times, then taking it out, placing it in a vacuum drying oven, and vacuum drying at 55° C. for 4 hours to obtain a melamine sponge composite material;
(4) adding dopamine hydrochloride to a Tris solution, stirring and mixing uniformly to obtain a treatment solution; adding the melamine sponge composite material to the treatment solution, performing ultrasonic dispersion for 10 minutes, adjusting the temperature to 65° C., maintaining a sealed impregnation for 15 hours, taking it out, and then vacuum drying at a temperature of 55° C. for 4 hours to obtain the composite modified sponge.

2. The preparation according to claim 1, wherein: the selected composite modified sponge has a density of 0.0080-0.0085 g/cm³ and a thickness of 0.4-0.6 cm.

3. The preparation method according to claim 1, wherein: in step (8), the curing agent is tetraethylenepentamine.

4. The preparation method according to claim 1, wherein:
the cleaned melamine sponge is immersed into the silver nanowire dispersion according to a volume ratio of 1:10;
the mixing ratio of dopamine hydrochloride to Tris solution is 1-1.2 g: 120 mL;
the volume ratio of the melamine sponge composite material to the treatment solution is 1:5.

5. The preparation method according to claim 1, wherein: the gallium-indium alloy has a mass fraction of gallium of 75.5% and a mass fraction of indium of 24.5%.

6. The preparation method according to claim 1, wherein: the multiple repetitions of steps (4) and (5) specifically means repeating 1-4 times.

7. The preparation method according to claim 1, wherein: the pressing pressure is 1 MPa, and the pressing time is 2 seconds per time.

8. The preparation method according to claim 1, wherein: in step (9), the dripping amount on each side of the film sample is 20 μL/cm², respectively.
